(19) United States
(12) Patent Application Publication
(10) Pub. No.: US 2020/0103224 A1
(43) Pub. Date: Apr. 2, 2020

(54) SYSTEM AND METHOD FOR SUPER-RESOLUTION FULL-FIELD OPTICAL METROLOGY ON THE FAR-FIELD NANOMETRE SCALE

(71) Applicants: UNIVERSITE DE STRASBOURG, Strasbourg (FR); CENTRE NATIONAL DE LA RECHERCHE SCIENTIFIQUE, Paris (FR)

(72) Inventors: Paul MONTGOMERY, Vendenheim (FR); Sylvain LECLER, Strasbourg (FR); Stéphane PERRIN, Strasbourg (FR); Audrey LEONG-HOI, Strasbourg (FR)

(21) Appl. No.: 16/604,942

(22) PCT Filed: Apr. 11, 2018
(86) PCT No.: PCT/EP2018/059306

§ 371 Date: Oct. 11, 2019

(30) Foreign Application Priority Data
Apr. 11, 2017 (EP) 17166026.9

(51) Int. Cl. G01B 11/24; G01B 9/02; G01B 9/04; G02B 27/58; G02B 21/14; G02B 21/36; G02B 21/32

(52) U.S. Cl. CPC G01B 11/2441; G01B 9/0201; G01B 9/04; G02B 21/32; G02B 27/58; G02B 21/14; G02B 21/365; G01B 9/0205

(57) ABSTRACT

A system of super-resolution full-field optical metrology for delivering information on the surface topography of a sample or object on the far-field nanometre scale, including a light source, an interferometer (1a, 1b, 1c, 1d) including a reference arm incorporating a micro bead and a mirror, an object arm including a micro bead similar to the micro bead and arranged in immediate proximity to the surface of the object, receiving structure for capturing the interference figures, and a processor for processing these interference figures in such a way as to produce surface topography information. The light source is temporally coherent or partially coherent. The interferometer and the processor for processing interference figures are designed to reconstruct the surface of the object by phase shifting interferometry.

### TECHNICAL FIELD

The present invention relates to a system and a method for super-resolution full-field optical metrology for delivering information on the surface topography of a sample on the far-field nanometre scale. It also relates to a metrology method implemented in this system.

This system and this method relate in particular to super-resolution optical profilometry. It is of interest in relation to nanometric spatial resolution, beyond the diffraction limit, obtained in the three spatial directions.

### STATE OF THE PRIOR ART

An optical profilometer is a non-contact metrology instrument making it possible to reconstruct the surface topography of an object. Several optical profilometry techniques exist such as confocal microscopy, structured-light projection and interferometric microscopy.

The principle of optical interferometry is similar to that of acoustic echography, because it makes it possible to reconstruct the depth information of an object by measuring the time-of-flight of a wave reflected by a junction between two materials of this object having different indices. In other words, in echography, the wave emitted by the transducer is reflected by a junction and is then collected by a receiver. The duration between emission and reception is called time-of-flight. By using the relationship between speed, time and distance, it is thus possible to find the relative position of the junction. Interferometry uses the same principle; i.e. measuring the time-of-flight. However, as the speed of light is much greater than the speed of sound, no sensor is currently capable of measuring this duration. This technique thus requires a more complex configuration, adding for example a reference arm.

In interferometry, the signal recorded by the receiver (an intensity image) is called an interference figure which carries optical path difference information. The receiver is generally a CCD (charge-coupled device) or CMOS (complementary metal-oxide semiconductor) matrix. By measuring the optical path difference between the reference wave (which is reflected by a mirror) and the wave reflected by the junction of the object, it is then possible to find the height information.

An interferometric profilometer thus uses this principle in order to reconstruct the topography of an object. Interferometry groups together two main measurement methods which are based on their illumination. Also, in order to diversify these two methods even further, there are multiple ways to interpret the results and to reconstruct the topography.

The first profilometry method uses a temporally coherent illumination. It comprises two methods for reconstructing the topography; these are digital holography and phase-shifting interferometry.

In digital holography, the depth (or optical path difference) information on each pixel depends on the phase shift between the reference wave and the object wave. The detector collects the interference figure. Then, by means of algorithms based on the propagation of the waves and the Fourier transform, the phase shift between the object wave and the reference wave is found. The technique has the advantage of only requiring a single acquisition. On the other hand, unlike phase-shifting interferometry, it requires a spatially coherent source and a more complex algorithm process.

In phase-shifting interferometry, the phase shift between the object wave and the reference wave is calculated based on a series of out-of-phase interference figures, making it possible to find the optical path difference on each pixel. The phase-shift is applied by axial displacement, by a known distance, of the object or the reference mirror. This technique allows a very high axial sensitivity, typically less than 1 nm.

These two coherent light optical metrology techniques are currently little used for optical profilometry because they are dependent on the coherence noise and speckle effects induced.

In coherent interferometry, the coherence function is approximated to 1. Therefore, the term for the optical path difference is thus found in the phase term. On the other hand, the second profilometry method uses a temporally incoherent or partially incoherent illumination (i.e. a polychromatic light source, for example a halogen lamp or an LED (light emitting diode)). Here, the principle is based on the fact that the interaction between two incoherent or partially incoherent waves forms an interference signal carried by a signal which is called the coherence function, which carries the optical path difference information on each pixel. Mathematically, this coherence function is expressed as a Fourier transform of the light source spectrum. The narrower the spectrum (in the case of a monochromatic source), the greater the coherence function, and vice versa.

Here, the depth information does not come from the phase term, but from the coherence term which itself carries the optical path difference information on each pixel. The detector records the light irradiance on each pixel which is the sum of the amplitudes of the object and reference waves squared. By axially displacing the object or the reference mirror, an interferogram is obtained on each pixel as a function of the position of the object. When the optical path difference between the plane of the mirror and the junction of the object is zero, the value of the envelope of the fringes is maximum on each pixel and an intensity peak appears. In other words, by scanning the optical path difference along the optical axis, the method detects this envelope peak per pixel then makes it possible to find the depth information of the object.

This technique is called white light interferometry or coherence scanning interferometry (CSI). It can be used not only for surface reconstruction (topography), but also for volume (tomography). The full width at half-maximum of the coherence function of the source is called coherence length and is an axial resolution criterion. The greater the spectrum width, the better the axial resolution. The method makes it possible to obtain an axial sensitivity less than approximately one hundred nanometers per sampling step. Envelope interpolation methods improve the sensitivity to approximately ten nanometers (by using a mathematical interpolation) up to a few nanometres (by using phase interpolation) according to the roughness of the surface.

However, the lateral resolution of an optical profilometer is limited by the diffraction originating mainly from the microscope objective.

According to the Abbe criterion, the theoretical value of the incoherent imaging resolution is λ/(2n sin a) where λ is the wavelength, a is the half-angle of the detection cone of the optical system and n is the refractive index of the medium. As the value of sin a is less than 1, the resolution is therefore greater than λ/(2n). Recently, new experimental methods have made it possible to go beyond this optical limit by using the principle of stimulated emission or lenses having a negative refractive index. However, these methods cannot be applied to full-field interferometry.

In 2010, Z. Wang et al. (Nature Communications 2, 218 (2011)) proposed an incoherent imaging method allowing the acquisition of a full-field image by placing a glass microsphere on the sample. This projects an enlarged virtual image of the object underlying the surface of the sample. The virtual image is then collected by a microscope objective. The microsphere, transparent at the range of wavelengths of the source, collects the evanescent waves and converts them into propagating waves. Thus, it can be made from glass, silica, polystyrene, melamine formaldehyde, barium titanate (in the event of immersion), etc. In addition, according to its diameter (between 3 μm and 150 μm) and its refractive index contrast (between 1.2 and 20), the performance varies. The index contrast is defined as the ratio between the refractive index of the microsphere and the refractive index of the ambient medium. A lateral resolution of 50 nm has been shown (Nature Communications 2, 218 (2011)). Since then, the phenomenon of lateral super-resolution has been the subject of numerous research works and numerous scientific publications for 2D imaging.

This phenomenon applies to lateral resolution, i.e. to 2D imaging. By placing a microsphere in the object arm of a Linnik interferometer, the possibility of reconstructing an object in 3D with a high axial and lateral resolution has been shown. In particular there may be mentioned the publication by F. Wang et al. (Scientific Reports 6, 24703 (2016)) on super-resolution applied to white-light or coherence scanning interferometry (CSI). In this publication, the coherence function is used in order to find the depth information of the object. It is thus necessary to use a light source having a low temporal coherence, usually denoted by the term “white light source”.

For the use of microspheres in super-resolution metrology at nanometre scale, there may be mentioned the documents CN103823353 “Sub wavelength super-resolution digital holographic imaging system based on microspheres”, WO2013043818 “Microsphere superlens based super resolution imaging platform” or CN102735878 “Super resolution microscopic imaging method and system based on micro cantilever and microsphere combined probe”.

The purpose of the present invention is to propose a far-field super-resolution full-field optical profilometry system having coherent or partially coherent illumination, which has better performance than the abovementioned current methods, both in terms of axial resolution and in terms of measurement sensitivity. The phase-shifting interferometry technique is used in order to find the optical path distribution of the sample.

### DISCLOSURE OF THE INVENTION

This objective is reached with a super-resolution full-field optical metrology system for delivering information on the surface topography of a sample or object on the far-field nanometre scale, comprising a coherent or partially coherent light source, an interferometer comprising an object arm incorporating a transparent microsphere placed in immediate proximity to the surface of the object, a reference arm incorporating a mirror, receiving means for capturing interference figures and means for processing said interference figures so as to produce said surface topography information, said interferometer and said means for processing interference figures being arranged in order to reconstruct the topography of the object by phase-shifting interferometry.

The microspheres utilized in the profilometry system according to the invention promote the evanescent wave phenomenon and thus contribute to achieving a super-resolution full-field image, which the scanning profilometry systems of the prior art do not allow.

It is understood that the microspheres utilized in the profilometry system according to the invention can be spherical, elliptical, hemispherical in shape, and more generally convex in shape. The temporally coherent or quasi-coherent light source can have a wavelength in the infrared, the visible or the close ultraviolet.

In a first embodiment, the interferometer is arranged in order to achieve measurements in a reflective configuration and can be of a type selected from the group of Michelson (1a), Twyman-Green (1b), Mirau (1c) and Mach-Zehnder interferometers.

In another embodiment, the interferometer can be arranged in order to achieve measurements in a transmissive configuration and can be of the Mach-Zehnder (1d) type.

In the prior art, the microspheres are placed on the surface of the object. This can damage the object in the case for example of biological samples or when the material of the object has a lower hardness coefficient than the material of the microsphere. By positioning the microsphere at a few nanometres from the surface of the object, it is possible to ensure a non-contact measurement. In an advantageous form of the invention, the microsphere is thus held away from contact with the surface of the sample. The microsphere is held by a support (for example of the mechanical tip, optical tweezer or perforated grid system type).

This microsphere can also be held above the surface of the sample by a piezoelectric displacement stage equipped with means for keeping said microsphere.

This microsphere can also be held above the surface of the sample by a micromanipulator arm equipped with means for keeping said microsphere or also by an optical tweezer. In a particular embodiment of a system according to the invention, the microsphere is placed in a microgrid placed above the surface of the sample and comprising holes of a diameter substantially less than that of said microsphere.

It can for example be placed in a gaseous, liquid or solid medium having a refractive index less than that of said microsphere, or in a transparent layer having a refractive index less than that of said microsphere and placed on the surface of the sample.

The microsphere (spherical, elliptical, hemispherical, convex in shape) can advantageously be arranged in order to concentrate a light beam (which is usually called the photonic jet) on the object.

In another particular embodiment, the reference arm also incorporates a microsphere similar to the microsphere of the object arm, said microsphere of the reference arm being placed in order to compensate for the dispersion.

It is also possible to provide an arrangement of the microspheres according to a translatable matrix configuration making it possible to reconstruct a larger field of view.

According to another aspect of the invention, a super-resolution full-field optical profilometry method is proposed for delivering information on the surface topography of a sample on the far-field nanometre scale, implemented in an optical metrology system according to the invention, said system incorporating an interferometer comprising an object arm equipped with a microsphere placed in immediate proximity to the surface of the sample and arranged in order to achieve interference figures.

The method according to the invention comprises:
illuminating said surface via the microsphere, for example spherical, elliptical, hemispherical, convex in shape, by means of a temporally coherent or quasi-coherent light source with a wavelength in the visible or the ultraviolet or the infrared, and
processing said interference figures in order to reconstruct the surface of the sample by phase-shifting interferometry.

It can also advantageously comprise concentrating a light beam on the object (photonic jet) and be arranged in order to achieve interferometric measurements in a reflective configuration.

In a particular embodiment of the optical metrology method according to the invention, the processing of the interference figures comprises:
Based on interference figures, producing a raw signal of the phase measured modulo 2π,
Cutting off said raw phase signal at an area of interest of the sample so as to limit the boundary effects,
Two-dimensional unwrapping of the phase image modulo 2π thus obtained,
Surface-fitting said thus-unwrapped phase image so as to remove the effects of aberrations,
Converting said thus-unwrapped, then surface-fitted, phase image to a height distribution, and
Processing said height distribution in order to plot surface profiles of said sample.

### DESCRIPTION OF THE FIGURES

Other advantages and characteristics of the invention will become apparent on reading the detailed description of implementations and embodiments that are in no way limitative, and from the following attached figures:

FIG. 1 diagrammatically illustrates four optical configurations used in reflection and an optical configuration used in transmission, for a metrology system according to the invention,

FIG. 2 diagrammatically illustrates a device for positioning a microsphere with respect to the surface of a sample,

FIG. 3 diagrammatically illustrates a matrix arrangement of microspheres (in this case, of the hemispherical type),

FIG. 4 diagrammatically illustrates a succession of steps implemented in the optical metrology method according to the invention, and

FIG. 5 diagrammatically illustrates a variant of the device for positioning a microsphere with respect to the surface of a sample, utilizing a piezoelectric actuator.

### DETAILED EMBODIMENTS

As these embodiments are in no way limitative, variants of the invention can be considered in particular comprising only a selection of the characteristics described or illustrated hereinafter, in isolation from the other characteristics described or illustrated (even if this selection is isolated within a phrase containing these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to differentiate the invention with respect to the state of the prior art.

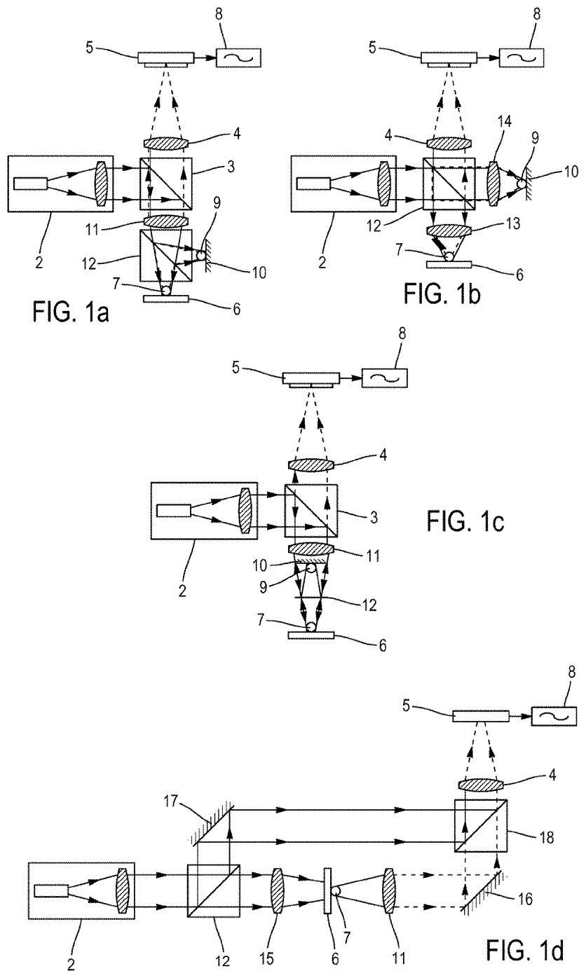

With reference to FIG. 1, three variants of an optical metrology system operating in reflective configuration based respectively on a Michelson interferometer 1a, a Twyman-Green interferometer 1b and a Mirau interferometer 1c, and a variant operating in transmissive configuration based on a Mach-Zehnder interferometer 1d are described according to the invention.

The components common to these four embodiment variants are mentioned below with identical references.

The configuration of the Michelson type 1a requires an illumination part comprising a source 2, temporally coherent or partially coherent, a collimator and a beam splitter 3, and an imaging part comprising the Michelson interferometer, a tube lens 4, a detector 5 and a device 8 for processing these interference figures in order to generate surface profiles of an object or sample 6.

An assembly (not shown in FIG. 1) of lenses and diaphragms makes it possible to obtain an illumination of the object that is homogeneous in intensity. In the Michelson interferometer, the reference and object arms are perpendicular to one another. The beam incident on a converging lens or an assembly of lenses 11 is split into beam fractions by a beam splitter 12 and oriented in the reference arm and the object arm. The reference arm comprises a microsphere or a matrix of microspheres 9 (spherical, elliptical, hemispherical, convex in shape) and a mirror 10. The microsphere is or is not in contact with the mirror. The object arm comprises a microsphere or a matrix of microspheres 7 similar to said microsphere of the reference arm, and the object or sample 6 to be characterized in reflection mode.

The detector 5 captures interference figures produced by the interference of an object beam originating from the object arm and a reference beam originating from the reference arm, and a device 8 processes these interference figures in order to generate surface profiles of the sample 6.

The tube lens 4 is placed at the exit of the beam splitter 3 in order to converge the two interference beams, measurement and reference, towards the detector 5, while the second lens 11 is placed between the first splitter device 3 and the second splitter device 12 in order to converge the illumination beam towards the object 6 to be measured.

The numerical aperture of the lens 11 is in practice limited by its working distance and thus is generally less than 0.3. With a microsphere of diameter greater than 30 μm, this therefore makes it possible to obtain a wide field of view.

The Twyman-Green configuration 1b shown in FIG. 1 is a variant of the Linnik configuration which is itself an improvement of the Michelson configuration insofar as it achieves an improved lateral resolution. This architecture requires an illumination part comprising a source 2, temporally coherent or partially coherent, equipped with a collimator, and an imaging part comprising a Twyman-Green interferometer, a tube lens 4, a detector 5 connected to a signal processing unit 8 in order to generate the topography of an object or sample 6. An assembly (not shown in FIG. 1) of lenses and diaphragms makes it possible to obtain an illumination of the object that is homogeneous in intensity.

In the Twyman-Green interferometer, the reference and object arms are perpendicular to one another and coupled by a beam splitter 12. The beam fractions are incident on two convergent lenses or two assemblies of lenses (one in each arm) 13 and 14. A portion of the beam is transmitted in the reference arm. The beam is then focused by the lens 14 and the microsphere or a matrix of microspheres 9 (spherical, elliptical, hemispherical, convex in shape) on the reference mirror 10 and reflected by the latter. The microsphere 9 is or is not in contact with the mirror 10. The reflected wave is collected by the microsphere 9 then the lens 14. The second part of the beam is reflected by the splitter 12 then directed into the object arm of the interferometer. The second lens 13 focuses the beam on the surface of the object 6 to be characterized in reflection mode, via a microsphere 7 similar to the microsphere 9 of the reference arm and placed in immediate proximity to this object. The wave is thus reflected or diffused by the surface of the object 6 then collected via the microsphere 7 by the lens 13. Like the reference wave, the object wave is transmitted by the tube lens 4 then imaged on the detector 5.

The detector 5 captures interference figures produced by the interference of an object beam originating from the object arm and a reference beam originating from the reference arm, and a device 8 processes these interference figures in order to generate surface profiles of the sample 6.

The tube lens 4 is placed at the exit of the splitter 12 in order to converge the two interference beams, measurement and reference, towards the detector 5.

The numerical aperture of the two identical lenses 13 and 14 is in practice not limited by its working distance and thus makes it possible to carry out the acquisition with a high lateral resolution. The Twyman-Green architecture provides the benefit of a compromise between lateral resolution and field of view.

The Mirau configuration 1c shown in FIG. 1 has an advantage with respect to the other architectures; that of a reduction in bulk. In fact, the reference arm is superimposed on the object arm and the optical axes of the reference and object arms are then merged. This architecture requires an illumination part comprising a source 2, temporally coherent or partially, coherent, equipped with a collimator and a beam splitter 3, and an imaging part comprising the Mirau interferometer, a tube lens 4, a detector 5 and a device 8 for processing these interference figures. An assembly (not shown in FIG. 1) of lenses and diaphragms makes it possible to obtain an illumination of the object that is homogeneous in intensity.

In the Mirau interferometer, the reference and object arms are parallel to one another. The beam incident on a convergent lens or an assembly of lenses 11 is split into fractions by a beam splitter 12 and oriented in the reference arm and the object arm. The reference arm comprises a microsphere or a matrix of microspheres 9 (spherical, elliptical, hemispherical, convex in shape) and a mirror 10. The microsphere is or is not in contact with the mirror. The object arm comprises a microsphere or a matrix of microspheres 7 similar to the microsphere of the reference arm, and the object 6 to be characterized in reflection mode.

The detector 5 captures interference figures produced by the interference of an object beam originating from the object arm and a reference beam originating from the reference arm, and a device 8 processes these interference figures in order to generate surface profiles of the sample 6.

The tube lens 4 is placed at the exit of the beam splitter 3 in order to converge the two interference beams, measurement and reference, towards the detector 5, while the second lens 11 is placed between the first splitter device 3 and the second splitter device 12 in order to converge the illumination beam towards the object 6 to be measured and the reference mirror 10.

The numerical aperture of the lens 11 is in practice limited by its working distance and thus is generally less than 0.5. With a microsphere of diameter greater than 30 μm, this thus makes it possible to obtain a wide field of view.

A configuration 1d of an optical metrology system, utilizing an interferometer of the Mach-Zehnder type, suitable for transmission measurements, will now be described with reference to FIG. 1. Transmission measurements are mainly used in biology, because the samples are often transparent at the wavelength.

A transmission measurement makes it possible to find the optical path difference induced by the object passed through. By knowing the refractive index of the object, the geometric height of the object is found, and vice versa.

The light beam originating from a source, coherent or partially coherent 2, is divided in two by a beam splitter 12. The beam transmitted by the splitter 12, called object beam, passes through an object or sample 6, after being optionally focused by an optional lens 15 which is provided in order to concentrate the light energy on the desired field of view and thus subsequently collect more light.

A microsphere 7 then a lens 11 collect the beam diffused by the object 6. A mirror 16 directs this object beam onto a detector 5, passing through a beam splitter 18 and a tube lens or relay lens 4.

The beam reflected by the beam splitter 12, called reference beam, is directed by a mirror 17 towards the beam splitter 18 where it is again directed onto the detector 5 via the tube lens 4.

The device 8 for processing the interference figures then makes it possible to find the lateral distribution (i.e. along X and Y) of the optical path of the object, in particular items of refractive index and geometric height information.

In the four configurations 1a, 1b, 1c and 1d which have just been described, the reference mirror 10 can be fixed to a piezoelectric device (not shown) which is controlled in order to achieve a lateral displacement of this mirror 10 around an equilibrium position, in order to obtain the phase shift. The microspheres 7 can be held at a short distance from the object 6 by another piezoelectric device (not shown).

It is important to note that, according to the invention, in the optical metrology systems that have just been described, it is possible to modify the polarization via polarizers and retardation plates, the uniformity of the lighting of the object via a lighting system, and the angles of the rays incident on the sample.

The microspheres 7, 9, which are utilized in the optical metrology systems 1a, 1b, 1c and 1d according to the invention described above with reference to FIG. 1, can be placed in air or immersed in a transparent material of the gaseous, liquid or solid type (for example, a polymer such as polydimethylsiloxane or PDMS).

In the different cases that have just been described, the measurable quantity in an optical metrology system according to the invention is an image or a series of 2D intensity images which is more usually called an interference figure. The items of information found are thus the surface topography of the object via phase-shifting interferometry. This phase-shift method is quicker than the known method of detecting the coherence function peak as it requires fewer acquisitions, and provides a better axial resolution. Four images are sufficient to reconstruct the surface topography of the object. The calculated phase shift between the reference wave and the object wave (interpreted as a retardation of the wave) makes it possible to find surface reliefs, i.e. the topography, via a conventional formula taking account of the dispersion of the microsphere.

For the different embodiments that have been described, the light source 2 must supply a high coherence. In addition, digital simulations as well as experimental measurements have shown that the use of a light source with a short wavelength provides a greater lateral resolution. For example, a blue light source close to UV provides a greater lateral resolution.

The light source 2 can be:
coherent, for example a laser source with a coherence length on a scale of metres,
quasi-coherent, for example a laser diode with a coherence length on a scale of centimetres,
partially coherent, for example a superluminescent diode with a coherence length on a scale of hundreds of micrometres,
partially incoherent, for example a light-emitting diode with a coherence length on a scale of tens of micrometres,
narrow filtering by wavelength, for example a supercontinuum and a filter,
in all cases, preferably with a short wavelength or with a spectrum centred on a short wavelength in the green, the blue, or even the ultraviolet, for example a blue LED at 450 nm.

The performance of a super-resolution profilometer according to the invention depends on several parameters such as the combination of the lens or the assembly of collection lenses and the microsphere, and the wavelength. It has been shown that an interferometer of the Twyman-Green configuration 1b described above with reference to FIG. 1 and comprising a close, short-wavelength light source and a glass microsphere having a diameter between 10 μm and 30 μm, makes it possible to resolve patterns of 100 nm in size. The microscope objective 13 placed in an immersion medium must have a numerical aperture of 0.9.

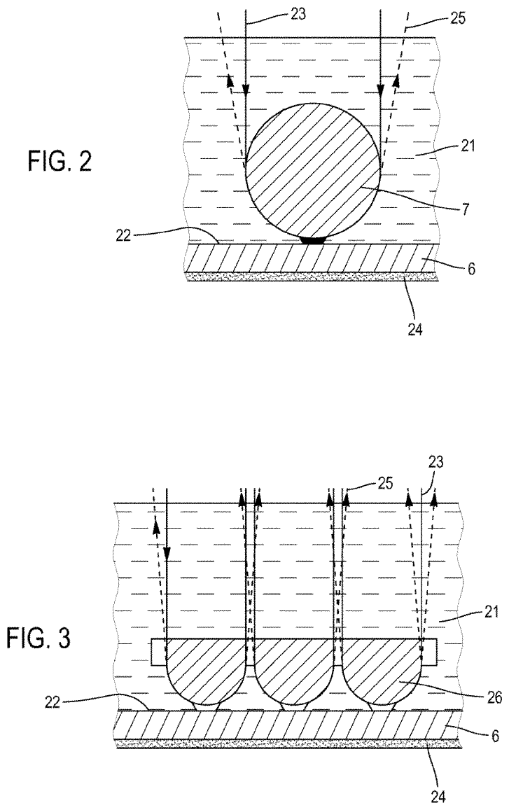

In the embodiment example illustrated in FIG. 2, a microsphere 7 intended to be placed in a measurement beam 23 within one of the optical metrology systems shown in FIG. 1, is included in an immersion layer 21. The refractive index of the medium constituting the layer 21 is less than that of the microsphere 7. This immersion layer 21 is placed on the surface 22 of the object 6 to be measured, for example a substrate, itself placed on a support 24. The microsphere 7 then collects the beam 25 reflected or diffused by the surface 22 of the object 6.

In an embodiment variant of the device in FIG. 2, illustrated in FIG. 5 in which components common to the two embodiments have common references, a coverslip 27 transparent at the wavelength of the light source is placed on the microsphere 7.

This coverslip 27 can be made from glass or any other transparent material and may have or may not have one and the same refractive index as the microsphere 7, which can be bonded, fused or held by a force, to the coverslip 27. The coverslip 27 is fastened to a piezoelectric actuator 28 which can control a vertical and/or horizontal displacement.

The refractive index contrast to be taken into account for the evaluation of the imaging performances is that between the microsphere 7 and the layer 21. For example, the microsphere 7 can be made from barium titanate and included in a layer 21 made from PDMS. It is also possible to provide for the microsphere to be placed in a perforated micro-grid of a diameter slightly less than the size of the microspheres in order to support them, or held by a micromanipulator arm with a tweezer or another adhesion system, or even held by an optical tweezer.

In addition, a matrix configuration of microspheres can be envisaged as illustrated in FIG. 3, where, in this example, a matrix of microspheres of the hemisphere type 26 is shown. The matrix of hemispheres provided to be placed in a measurement beam 23 within one of the optical metrology systems shown in FIG. 1, is included in an immersion medium 21. The refractive index of the medium 21 is less than that of the microsphere 26. This immersion layer 21 is placed on the surface 22 of the object 6 to be measured, for example a substrate, itself placed on a support 24. The microsphere 7 then collects the beam 25 reflected or diffused by the surface 22 of the object 6.

This matrix arrangement of microspheres is particularly suitable with the use of a matrix of Mirau interferometers due to the reduced bulk, and it makes it possible to increase the field of view while maintaining a similar acquisition rate.

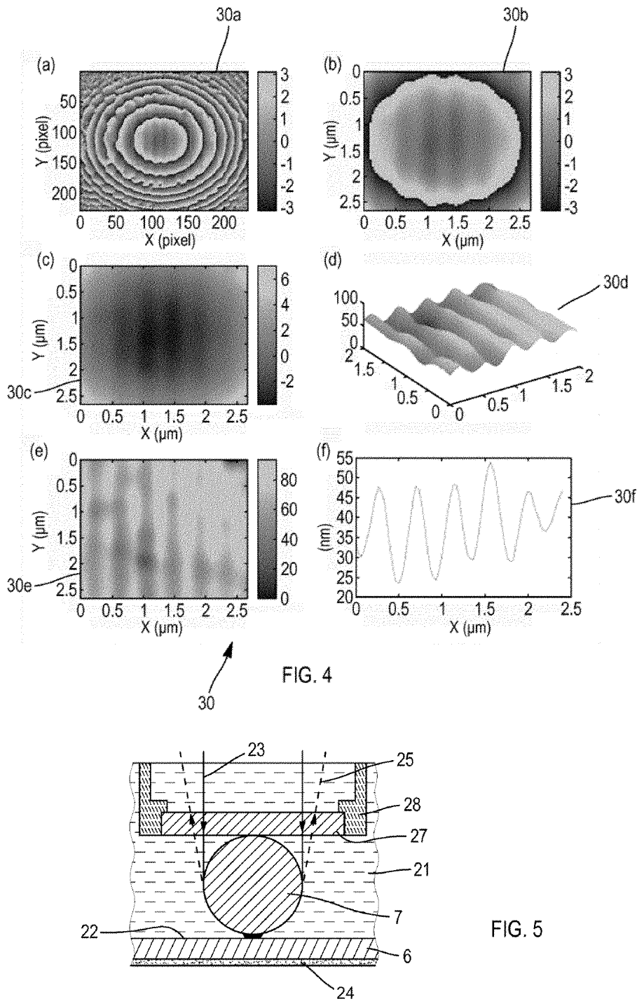

A practical example of a processing of the interference figures obtained with the optical metrology method according to the invention will now be described with reference to FIG. 4. Processing the signal in phase-shifting interferometry requires the unwrapping of the phase.

The raw signal 30a of the phase measured modulo 2π is cut off at an area of interest 30b of the object in order to limit the boundary effects. The phase image is then unwrapped 30c in two dimensions then surface-fitted in order to remove the effects of aberrations.

This thus-processed image is then converted to a height distribution 30e. A dedicated programme then makes it possible, from this height distribution, to plot surface profiles 30f.

Of course, the invention is not limited to the examples that have just been described, and numerous modifications may be made to these examples without exceeding the scope of the invention. Of course, the various characteristics, forms, variants and embodiments of the invention can be combined together in various combinations inasmuch as they are not incompatible or mutually exclusive. In particular, all the variants and embodiments described above can be combined together.

1. A super-resolution full-field optical metrology system for delivering information on the surface topography of a sample or object on the far-field nanometre scale, comprising: a coherent or partially coherent light source; an interferometer comprising an object arm incorporating a transparent microsphere and placed in immediate proximity to the surface of the object; a reference arm incorporating a mirror; receiving means for capturing interference figures and means for processing said interference figures so as to produce said surface topography information;
said interferometer and said means for processing interference figures being arranged in order to reconstruct the topography of the object by phase-shifting interferometry.

2. The system according to claim 1, characterized in that the light source is temporally coherent or quasi-coherent with a wavelength in the visible spectrum.

3. The system according to claim 1, characterized in that the light source is temporally coherent or quasi-coherent with a wavelength in the infrared spectrum.

4. The system according to claim 1, characterized in that the light source is temporally coherent or quasi-coherent with a wavelength in the ultraviolet spectrum.

5. The system according to claim 1, characterized in that the interferometer is arranged in order to achieve measurements in a reflective configuration.

6. The system according to claim 5, characterized in that the interferometer is of a type selected from the group of Michelson, Twyman-Green, Mirau and Mach-Zehnder interferometers.

7. The system according to claim 1, characterized in that the interferometer is arranged in order to achieve measurements in transmissive configuration.

8. The system according to claim 7, characterized in that the interferometer is of the Mach-Zehnder type.

9. The system according to claim 1, characterized in that the reference arm also comprises a microsphere similar to the microsphere of the object arm, said microsphere of the reference arm being placed in order to compensate for the dispersion, and placed in immediate proximity to the surface of the mirror.

10. The system according to claim 1, characterized in that it comprises, in the object arm and in the reference arm, a plurality of microspheres arranged in the form of a translatable matrix of microspheres.

11. The system according to claim 1, characterized in that the microspheres(s) microsphere or microspheres are spherical, elliptical, hemispherical or convex in shape.

12. The system according to claim 1, characterized in that the microsphere or microspheres are placed in contact with the surface of the object or the surface of the reference mirror.

13. The system according to claim 1, characterized in that the microsphere or microspheres are held away from contact with the surface of the object or with the surface of the reference mirror.

14. The system according to claim 13, characterized in that the microsphere or microspheres are placed in a transparent layer placed on the surface of the object and having a refractive index less than that of said microsphere or microspheres.

15. The system according to claim 13, characterized in that the microsphere or microspheres are held above the surface of the object by a micromanipulator arm equipped with means for keeping said microsphere or microspheres.

16. The system according to claim 13, characterized in that the microspheres are held above the object by an optical tweezer.

17. The system according to claim 13, characterized in that the microspheres are held above the object by a piezoelectric system.

18. The system according to claim 13, characterized in that the microsphere or microspheres are placed in a micro-grid placed above the surface of the object and comprising holes of diameter substantially less than that of said microsphere or microspheres.

19. A super-resolution full-field optical metrology method for delivering information on the surface topography of an object on the far-field nanometre scale, implemented in an optical metrology system according to claim 1, said system incorporating an interferometer comprising an object arm equipped with a microsphere placed in immediate proximity to the surface of the object and being arranged in order to achieve interference figures,
this method comprising:
illuminating the surface via said microsphere, by means of a temporally coherent or partially coherent light source; and
processing the interference figures in order to reconstruct the surface of the object by phase-shifting interferometry.

20. The method according to claim 19, characterized in that it achieves interferometric measurements in reflective configuration.

21. The method according to claim 19, characterized in that it achieves interferometric measurements in transmissive configuration.

22. The method according to claim 19, characterized in that it achieves interferometric measurements in matrix configuration.

23. The method according to claim 19, characterized in that the processing of the interference figures comprises:
based on a phase measurement in images of interference figures, producing a raw signal of the phase measured modulo 2π;
cutting off said raw phase signal in an area of interest of the object so as to limit the boundary effects;
two-dimensional unwrapping of the phase image thus obtained,
surface-fitting said thus-unwrapped phase image so as to remove the effects of aberrations;
converting said thus-unwrapped, then surface-fitted, phase image into a height distribution; and
processing said height distribution in order to plot surface profiles of said object.

24. The method according to claim 19, characterized in that the processing of the interference figures comprises an optimization algorithm used in order to seek to bring the measurements closer to the results of a simulation describing the ball-object interaction.
